(19) United States
(12) Patent Application Publication
(10) Pub. No.: US 2016/0176226 A1
(43) Pub. Date: Jun. 23, 2016

(54) Writing Instrument With Holder Element

(71) Applicant: Philip Chatterton, Charlotte, NC (US)

(72) Inventor: Philip Chatterton, Charlotte, NC (US)

(21) Appl. No.: 14/577,080

(22) Filed: Dec. 19, 2014

(51) Int. Cl. B43K 25/02; A45C 11/18

(52) U.S. Cl. CPC B43K 25/02; A45C 11/18; A45C 11/182

(57) ABSTRACT

A writing instrument includes a housing having a first end and a second end, and a holder member coupled to the housing, wherein the holder member includes a first part extending toward the second end of the housing and having a first retaining element for retaining a first object between the housing and the first part, and a second part extending toward the first end of the housing and having a second retaining element for retaining a second object between the first and second parts, wherein the second part at least partially extends over the first part.

### FIELD OF THE INVENTION

The present invention relates to the field of hand-held writing instruments having means for attaching various articles thereto. In particular, the present invention relates to a writing instrument having a holder element with two parts capable of retaining two articles therein, such as, e.g., a credit card and a credit card receipt, wherein the articles are inserted from into the holder element from different directions.

### BACKGROUND OF THE INVENTION

Consumers often require an easy access to a writing instrument, such as a pen, in their daily lives. However, it is not always practical for a consumer to carry the writing instrument with them. As a result, many establishments provide writing instruments for use by consumers. One common example of such situation is when a waiter in a restaurant brings a check to a customer. Typically, the check is placed in a bulky hard cover folder together with a pen, so that the customer may sign the check and place a copy with the pen back into the folder. One problem with using the check folders is that they get dirty and wear out easily and often are not very attractive in appearance. Also, such procedure is not very effective for marketing purposes because the customers have nothing to take with them to remember the restaurant's name and contact information.

Therefore, it is desirable to have a writing instrument that can retain a customer's credit card together with a credit card receipt, thereby eliminating the need for hard cover check folders. After signing the check, the customer has an option of keeping the pen, which can include the restaurant's name and contact information, in case the customer wants to return to the restaurant. It is also desirable to have an easy and cost effective way of customizing the products for a particular customer.

There are a number of existing writing instruments having various holder means. For example, U.S. Pat. No. 3,961,852 to Parry is directed to a writing instrument with a removable cap and a regular or stylus type writing end. The cap has a pocket engaging clip at one end and a smooth flat plate that may carry various things, e.g. writing pad, erasable notepad, ruler, etc., permanently or removably attached at the other end. The flat plate may be attached to the cap by two round clasps and may have a hinged cover that is opened to access the writing pad paper or the erasable writing pad.

U.S. Pat. No. 5,813,786 to Fraenkel is directed to a writing instrument that may be attached to an article, e.g. credit card. The writing instrument has a cylindrical body with at least two opposingly biased resilient jaws or projections extending from the body. A credit card is inserted between the resilient jaws and thus, is secured to the writing instrument.

U.S. Pat. No. 1,607,894 to Johnson is directed to a name clip for use with pens and pencils. The clip is made from a unitary sheet of material, such as metal, and has a rectangular flat body with flanges extending along the perimeter of the body. A piece of paper, such as a name tag, is inserted into the channels formed by the flanges. The clip is attached to the pen or pencil by a pair of resilient bands that grip the pen/pencil body. The clip also has a protrusion extending towards the pen/pencil body such that the clip may be used to attach the pen or pencil to an article of clothing, etc.

U.S. Pat. No. 3,846,927 to Geffen is directed to a writing instruments including a combination display device and a pocket clip. The display device is a plate with a display surface that is attached to one side of the writing instrument cap. A portion of the plate overlies but is unsecured to the cap such that the margin of a shirt pocket or another article may be pushed between the plate and the cap.

U.S. Pat. No. 5,863,072 to Sommer is directed to a data tag for use with a writing instrument. The data tag is a strip of material with a tab that is inserted between the writing instrument body and a clip attached to the writing instrument body. The tab snaps into a recess provided on the clip to secure the data tag to the writing instrument.

U.S. Pat. No. 1,073,053 to Lawson et al. is directed to a combined pencil clip and a tape measure. The clip has curved attaching ears that grip the pencil body and a tongue piece that extends upwardly and outwardly from the clip body. A tape measure case is attached to the clip tongue such that its lower portion extends below the lover edge of the clip body and forms a gripping jaw used to attach the pencil to an article of clothing.

However, the above discussed prior art writing instruments still suffer from a number of disadvantages. First, many of them are designed to retain only one article at a time. Additionally, some of the prior art writing instruments with holding means are rather complex in design, thereby requiring higher manufacturing costs and making it more difficult and thus, less desirable, for consumers to use. Furthermore, the prior art writing instruments are not capable of being easily customized based on customer's promotional needs.

What is desired, therefore, is a writing instrument with an improved holder element that retains at least two articles, e.g., a credit card and a credit card receipt, at the same time. What is also desired is a writing instrument with an improved holder element that is very simple in design, without requiring additional parts or manufacturing steps for assembly with the product, thereby reducing manufacturing time and costs. What is further desired is a writing instrument with an improved holder element that may be easily customized with any desirable decorative pattern, such as companies' logos, and then used with already manufactured components, thereby providing a custom-made but cost efficient product.

### SUMMARY OF THE INVENTION

In order to address the shortcoming of the prior art systems and to achieve at least the above-mentioned objectives, a writing instrument with a holder element is provided, including a housing having a first end and a second end, and a holder member coupled to the housing, wherein the holder member has a first part extending toward the second end of the housing and having a first retaining element for retaining a first object between the housing and the first part, and a second part extending toward the first end of the housing and having a second retaining element for retaining a second object between the first and second parts, and wherein the second part at least partially extends over the first part.

In some embodiments, the holder member is removably coupled to the housing.

In certain embodiments, the second part of the holder member is removably coupled to the first part of the holder element. In some of these embodiments, the second part is coupled to the first part via a snap-fit connector.

In some embodiments, the first retaining element includes a raised portion of the first part of the holder element that extends toward the housing, and the second retaining element includes a raised portion of the second part of the holder element that extends toward the first part.

In certain embodiments, the second part of the holder member has a top surface with a decorative pattern. In some of these embodiments, the decorative pattern is printed on the top surface of the second part. In additional of these embodiments, the decorative pattern is three-dimensional.

In some cases, the holder element is coupled to the housing adjacent the first end of the housing.

In certain embodiments, the first object is a credit card receipt and the second object is a credit card. In additional embodiments, the first object is a document the second object is a business card.

A method for attaching objects to a writing instrument is also provided, including the steps of placing a first object between a housing of the writing instrument and a first part of a holder member coupled to the housing, placing a second object between the first part of the holder element and a second part of the holding element, engaging the first object by a first retaining element positioned on the first part of the holder member, and engaging the second object by a second retaining element positioned on the second part of the holder member.

In some embodiments, the holder member is removably coupled to the housing.

In certain embodiments, the method further includes the steps of removing the second part of the holder member and replacing it with a different second part. In some of these embodiments, the second part is coupled to the first part via a snap-fit connector.

In some cases, the first retaining element is a raised portion of the first part of the holder element that extends toward the housing, and the second retaining element is a raised portion of the second part of the holder element that extends toward the first part.

In certain embodiments, the second part of the holder member has a top surface with a decorative pattern. In some of these embodiments, the decorative pattern is printed on the top surface of the second part. In further of these embodiments, the decorative pattern is three-dimensional.

In some embodiments, the holder element is coupled to the housing adjacent the first end of the housing.

In certain embodiments, the first object is a credit card receipt and the second object is a credit card. In additional embodiments, the first object is a document the second object is a business card.

Other objects of the invention and its particular features and advantages will become more apparent from consideration of the following drawings and accompanying detailed description.

### BRIEF DESCRIPTION OF THE DRAWINGS

FIG. 1 is side view of a writing instrument with a holder element of the present invention.

FIG. 2 is a top view of the writing instrument of FIG. 1.

FIG. 3A is a top view of the writing instrument of FIG. 1, showing objects inserted into the holder element.

FIG. 3B is a side view of the writing instrument of FIG. 1, showing objects inserted into the holder element.

FIG. 4A is a side view of the writing instrument of FIG. 1, with a different holder element.

FIG. 4B is a top view of the writing instrument of FIG. 4A.

FIG. 5A is a top view of the writing instrument of FIG. 1, showing objects inserted into the holder element.

FIG. 5B is a side view of the writing instrument of FIG. 1, showing objects inserted into the holder element.

### DETAILED DESCRIPTION OF THE INVENTION

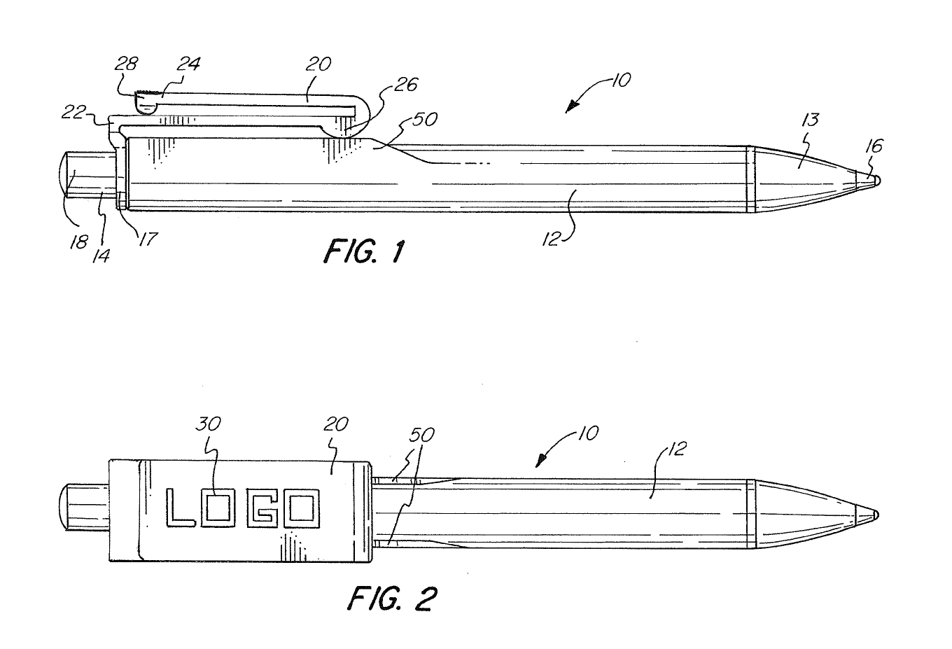

The basic components of one embodiment of a writing instrument with a holder element in accordance with the invention are illustrated in FIG. 1. As used in the description, the terms “top,” “bottom,” “above,” “below,” “over,” “under,” “above,” “beneath,” “on top,” “underneath,” “up,” “down,” “upper,” “lower,” “front,” “rear,” “back,” “forward” and “backward” refer to the objects referenced when in the orientation illustrated in the drawings, which orientation is not necessary for achieving the objects of the invention.

The invention relates to a pen having a holder member that can be used to hold various things, such as credit cards, credit card receipts, documents, business cards, etc.

As shown in this figure, the writing instrument, e.g. a pen (10), has a housing (12), which can be made with any suitable material, such as, e.g., plastic, metal, etc. The housing has a front end (13) and a rear end (14). The housing (12) accommodates a writing instrument (16), such as ink cartridge. The front end (13) of the housing (12) has an opening through which the writing instrument (16) is extended out when the pen is in use. The writing instrument (16) may be extended out of the housing (12) by pressing a button (18), or any other suitable actuator, provided at the rear end (14) of the housing (12), which engages another actuator provided inside the housing and causes the writing instrument to extend out of the opening at the distal end. It is understood that any suitable mechanism may be used to bring the writing instrument into an extended position.

The pen (10) also has a holder member (20) coupled to the pen housing (12). In the embodiment shown in FIGS. 1 and 2, the holder member (20) is coupled to the rear end (14) of the housing (12). However, it is understood that, in other embodiments, the holder member (20) may be coupled to the front end (13) of the housing or at any other location along the housing (12). The holder member (20) may be coupled to the housing by any suitable mechanism. For example, as shown in FIG. 1, the holder member (20) has a ring (17) attached to it that fits over the button actuator (18). Any other attachment mechanism may be used in accordance with the present invention.

In some embodiments, the holder member (20) is permanently attached to the housing (12), e.g., by gluing it to the housing. In additional embodiments, the holder member (20) is removably attached to the housing (12), e.g., by snap-fit connector, such that it can be easily removed and replaced with a different holder member or a simple clip for attachment to an article of closing, luggage or a writing pad and the like.

The holder member (20) has a first part (22) that is positioned adjacent the housing (12) and extends from the rear end (14) of the housing towards the front end (13) of the housing. The holder member (20) also has a second part (24) that is positioned over the first part (22) and extends in the opposite direction towards the rear end (14) of the pen. The first part (22) and the second part (24) are connected though a curved section, such that the holder element has a flattened C-shape.

The holder member (20) is made out of any resilient plastic or other type of material that has some flexibility such that the first and second parts (22) and (24) may be bent slightly to insert one or more objects therein. The objects may be placed between the body of the pen and the first portion, and between the first and second portions.

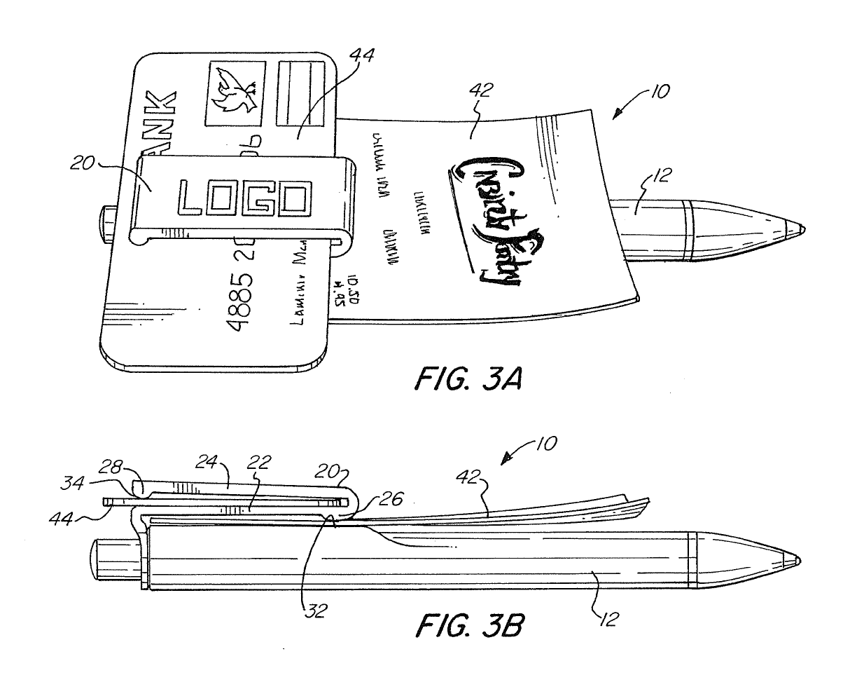

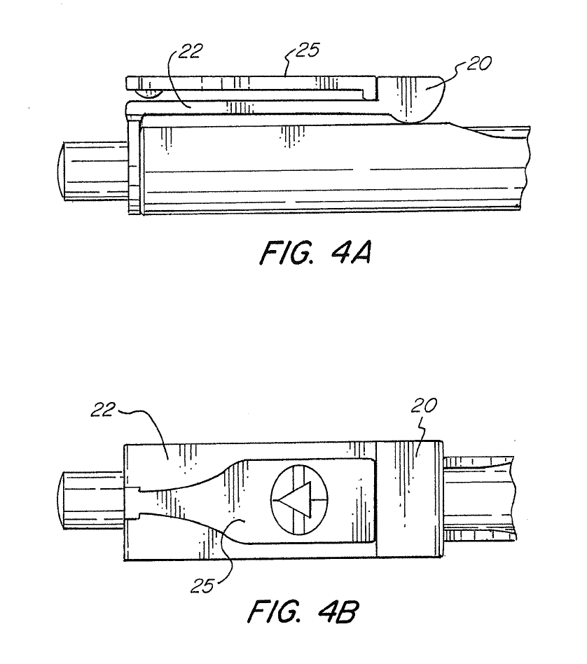

As shown in FIG. 1, the second part (24) is shorter in length that the first part (22) such that it does not entirely cover the first part (22). The advantage of this design is that it makes it easier for a user to slide an object between the first and second parts (22) and (24). However, it is understood that the second part (24) may have approximately the same length as the first part (22) such that extends over the entire length of the first part (22), as shown in FIGS. 3B and 4A below.

In the exemplary embodiment shown in FIGS. 1 and 2, the housing (12) also includes two ridges (50) extending from the outer surface of the housing parallel to each other. The ridges (50) are positioned adjacent the holder member (20) such that each ridge (50) is positioned substantially below one of the side edges of the first part (22) of the holder member (20). The ridges (50) assist in retaining an object between the housing (12) and the first part (22) of the holder member (10). Because the housing (12) has a cylindrical outer surface and the first part (22) of the holder member (10) has a flat planar surface, the fit between the two may not be sufficient to securely retain an object. By providing the raised ridges (50), a better fit between the bottom surface of the first part (22) and the housing surface is assured to more securely retain the object therebetween. It is understood, however, that some embodiments of the present invention may not have ridges or may have some other mechanism, such as modified shape of a portion of the housing, to assist in retaining the object in the holder member.

FIGS. 3A and 3B show the writing instrument (10) with a credit card (44) and a credit card receipt (42) inserted into the holder member (20). The credit card receipt (42) is inserted between the first part (22) of the holder element and the housing (12) through a first open end (32). The credit card (44) is inserted between the first part (22) and the second part (24) of the holder element through a second open end (34) opposite the first open end. This way, the pen with the inserted credit card and the credit card receipt is conveniently brought to a customer at a restaurant, eliminating the need for customary credit card and receipt folders. Additionally, the pen with the clip bearing the restaurant's name/logo and/or contact information functions as a marketing material that the customer may take home with him/her.

It is understood that only one object may be inserted into the holder member (20) if desired, or more than two objects may be inserted between the housing and the first part and the first and second parts of the holder member. It is also understood that any type of object may be inserted into the holder member as desired.

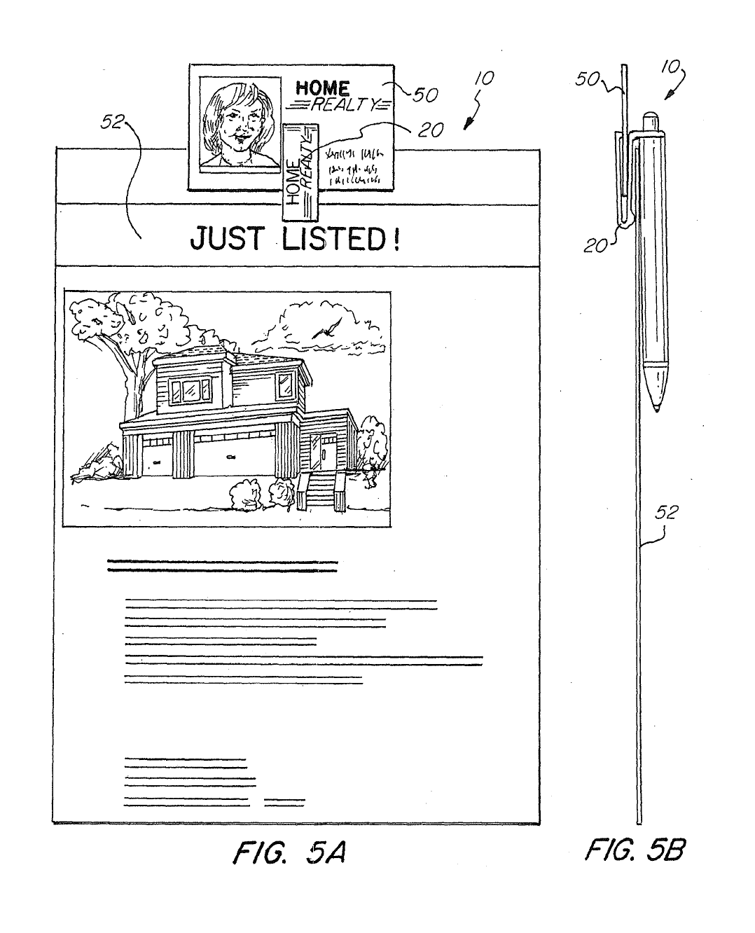

In one advantageous embodiment shown in FIGS. 5A and 5B, a real estate document (52), such as a property specification, and a real estate agent's business card (50) may be inserted into the holder member (20). When the real estate agent shows a property to a client, he or she may hand the pen (12) with the property spec (52) and the business card (50) inserted into the clip (20) to the client to take home with them. The top surface of the holder member itself may bear a real estate business name and/or logo. In additional advantageous embodiments, a product information brochure, such as e.g. a car marketing document, may be inserted into the holder member together with a car dealer's business card to be handed out to potential or existing customers. The holder member may include a name/logo of the car dealership and/or the name/logo or a particular car brand.

As seen from the side view in FIG. 3B, the holder element has a first retaining element (26) and a second retaining element (28). In the exemplary embodiment shown in this figure, the first retaining element (26) comprises a raised portion extending from the first part (22) toward the housing (12), and the second retaining element (28) comprises a raised portion (28) extending from the second part (24) of the holder member toward the first part (22) of the holder member. The first retaining element (26) is placed near the first open end (26) such that it retains the first object (42) between the first part (22) of the holder member and the housing (12) and prevents it from slipping out. Similarly, the second retaining element (28) is positioned adjacent the second open end (38) to retain the second object (44) between the first and second parts (22, 24) of the holder member. It is understood that other type of retaining mechanism may also be used in accordance with the present invention.

In some embodiments, the top portion of the holder element (20) may include a decorative pattern. As shown in FIGS. 1 and 2, the top surface of the second part (24) of the holder member (20) may include a two-dimensional pattern, such as a corporate identifier, logo or name, or any other marketing material, produced by printing or any other suitable technique. In other embodiments, the top portion of the second part (24) of the holder member (20) may include a three-dimensional pattern placed on the top surface of the decorative portion. Such pattern is produced by any known suitable technique, such as, for example, etching or three-dimensional printing. In additional embodiments, the shape of the first and second parts of the holder member (20) itself may be used to provide the decorative element, such as illustrated in FIG. 4B.

In some embodiments, as shown in FIGS. 4A and 4B, the second part of the holder member (20) is removably attached to the first part (22) of the holder member (20) such that the second part may be detached and replaced with a different second part (25) having a different shape, insignia, etc., to allow for low-cost customization of the pen. The second part is attached to the first part by any suitable mechanism. In some embodiments, the first part (22) and the second part (25) of the holder member may be provided with mating connectors, such as snap-fit, slide on or screw on connectors, that engage when the second part (25) is placed over the first part (22). This design allows the manufacturer and/or customer to easily remove the second part and exchange it for a different second part having different indicia to customize the writing instrument for different customers or different marketing purposes.

It should be understood that the foregoing is illustrative and not limiting, and that obvious modifications may be made by those skilled in the art without departing from the spirit of the invention. Although the invention has been described with reference to embodiments herein, those embodiments do not limit the scope of the invention

What is claimed is:

1. A writing instrument, comprising:
a housing having a first end and a second end; and
a holder member coupled to the housing, wherein said holder member comprises:
a first part extending toward the second end of the housing and having a first retaining element for retaining a first object between said housing and said first part; and
a second part extending toward the first end of the housing and having a second retaining element for retaining a second object between said first and second parts, wherein the second part at least partially extends over the first part.

2. The writing instrument of claim 1, wherein said holder member is removably coupled to the housing.

3. The writing instrument of claim 1, wherein said second part of said holder member is removably coupled to said first part of the holder element.

4. The writing instrument of claim 3, wherein said second part is coupled to said first part via a snap-fit connector.

5. The writing instrument of claim 1, wherein the first retaining element comprises a raised portion of the first part of the holder element that extends toward the housing, and the second retaining element comprises a raised portion of the second part of the holder element that extends toward the first part.

6. The writing instrument of claim 1, wherein said second part of said holder member has a top surface with a decorative pattern.

7. The writing instrument of claim 6, wherein the decorative pattern is printed on the top surface of said second part.

8. The writing instrument of claim 6, wherein the decorative pattern is three-dimensional.

9. The writing instrument of claim 1, wherein said holder element is coupled to the housing adjacent the first end of the housing.

10. The writing instrument of claim 1, wherein the first object is a credit card receipt and the second object is a credit card.

11. The writing instrument of claim 1, wherein the first object is a document and the second object is a business card.

12. A method for attaching objects to a writing instrument, comprising the steps of:
placing a first object between a housing of said writing instrument and a first part of a holder member coupled to the housing;
placing a second object between the first part of the holding element and a second part of the holder element;
engaging the first object by a first retaining element positioned on the first part of the holder member; and
engaging the second object by a second retaining element positioned on the second part of the holder member.

13. The method of claim 12, wherein said holder member is removably coupled to the housing.

14. The method of claim 12, further comprising the steps of removing the second part of the holder member and replacing it with a different second part.

15. The method of claim 14, wherein said second part is coupled to said first part via a snap-fit connector.

16. The method of claim 12, wherein the first retaining element comprises a raised portion of the first part of the holder element that extends toward the housing, and the second retaining element comprises a raised portion of the second part of the holder element that extends toward the first part.

17. The method of claim 12, wherein said second part of said holder member has a top surface with a decorative pattern.

18. The method of claim 17, wherein the decorative pattern is printed on the top surface of said second part.

19. The method of claim 17, wherein the decorative pattern is three-dimensional.

20. The method of claim 12, wherein said holder element is coupled to the housing adjacent the first end of the housing.

21. The method of claim 12, wherein the first object is a credit card receipt and the second object is a credit card.

22. The method of claim 12, wherein the first object is a document and the second object is a business card.
